(19) United States
(12) Patent Application Publication
(10) Pub. No.: US 2021/0400877 A1
(43) Pub. Date: Dec. 30, 2021

(54) MOWER FOLDING-TYPE CHASSIS

(71) Applicant: Ningbo Langhui Tools Co., Ltd., Ningbo (CN)

(72) Inventor: Yanhui ZHAO, Ningbo (CN)

(21) Appl. No.: 16/325,643

(22) PCT Filed: Jan. 14, 2019
(86) PCT No.: PCT/CN2019/071545

§ 371 Date: Sep. 9, 2021

(30) Foreign Application Priority Data
Dec. 6, 2018 (CN) 201811486847.X

(51) Int. Cl. A01D 67/00; A01D 34/66; A01D 34/76; A01D 69/00

(52) U.S. Cl. CPC A01D 67/00; A01D 34/66; A01D 2101/00; A01D 69/00; A01D 34/76

(57) ABSTRACT

A mower folding-type chassis, comprising a fixing disc and at least one rotating disc rotationally connected with the fixing disc; the fixing disc is fixedly arranged at the bottom of the mower; mowing blades are respectively arranged within the shells of the fixing disc and the rotating disc; a driving device used for driving the mowing blades to rotate is arranged in the mower; when mowing a lawn, the rotating discs can be rotated and unfolded relative to the fixing disc, thereby improving the mowing efficiency, and when the mower needs to be stored or transported, the rotating discs can be rotated and folded relative to the fixing disc, thus reducing the space occupation of the mower.

### TECHNICAL FIELD OF THE INVENTION

The present invention relates to the technical field of mowers, and more particularly, to a mower folding-type chassis.

### BACKGROUND OF THE INVENTION

With the continuous development of living standards, people have higher demands on environmental landscaping. Lawns, playing an important role in the greening of urban areas, are maintained at a short height with mowers for aesthetic and recreational purposes. In the prior art, traditional lawn mowers sold on the market are mainly divided into a riding-type, a pushed-type and a handheld-type. The riding-type mower is normally four-wheeled, allowing an operator to ride on. It's high-powered, highly-efficient and suitable for mowing large lawn areas such as a football field, a golf course or a city park. The pushed-type mower has lower power consumption and smaller size, thus being used for mowing smaller lawn areas such as greenbelts along roads. The handheld-type mower is smaller and portable, designed specifically for lawn areas that are very small or incapable of being touched by a large mower.

A crucial part of a riding mower or a pushed mower is the chassis arranged at the bottom of the mower, wherein mowing blades are arranged in the chassis, and a driving motor is installed in the mower for driving the blades to rotate. For the mowing efficiency depends on the length of the blades, when mowing a large lawn, a user needs longer blades for improving the mowing efficiency. However, longer mowing blades require a fixed chassis with corresponding size, resulting in the increase of the mower's size and cost of storage and transportation.

### SUMMARY OF THE INVENTION

The purpose of the present invention is to solve the shortcomings in the prior art by providing a mower folding-type chassis. Through a fixing disc and at least one rotating disc connected with the fixing disc, when mowing a lawn, the rotating discs can be rotated and unfolded relative to the fixing disc, thereby improving the mowing efficiency, and when the mower needs to be stored or transported, the rotating discs can be rotated and folded relative to the fixing disc, thus reducing the space occupation of the mower.

To achieve the above purpose, the present invention adopts the following technical solution:

A mower folding-type chassis, comprising a fixing disc and at least one rotating disc rotationally connected with the fixing disc; the fixing disc is fixedly arranged at the bottom of the mower; mowing blades are respectively arranged within the fixing disc and the rotating disc; a driving device used for driving the mowing blades to rotate is arranged in the mower.

In another aspect of the present invention, the number of the rotating discs is two, and the two rotating discs are respectively rotationally connected with the fixing disc.

In another aspect of the present invention, when the number of the rotating discs is more than two, two of the rotating discs are respectively rotationally connected with the fixing disc, and the rest of the rotating discs are respectively rotationally connected with the rotating discs that are connected with the fixing disc.

In another aspect of the present invention, the driving device comprises a plurality of driving motors, which are respectively arranged on the fixing disc and the rotating disc. The driving motors are respectively in transmission connection with the mowing blades in the fixing disc and the rotating disc.

In another aspect of the present invention, the driving device comprises a driving motor, and the mowing blades in the fixing disc and the rotating disc are respectively connected with a belt wheel. A belt is arranged between the belt wheel on the fixing disc and that on the rotating disc in a sleeved mode. The driving motor is in transmission connection with the belt wheel on the fixing disc.

In another aspect of the present invention, the rotating disc is rotationally connected with the fixing disc through a rotating arm. A lead-screw motor is arranged on the mower. An output end of the lead-screw motor is in transmission connection with a lead screw. A sliding block is arranged on the lead screw, and the sliding block is connected with a rocking bar. The rocking bar is connected with the rotating arm.

In another aspect of the present invention, the rotating disc is rotationally connected with the fixing disc through a rotating arm. A lead screw is arranged on the mower, and a sliding block is arranged on the lead screw. The sliding block is connected with a rocking bar, and the rocking bar is connected with the rotating arm. The end portion of the lead screw is connected with a handle seat, and a handle is rotationally connected with the handle seat. A handle fixing device is arranged on the lead screw, and a clamping groove matched with the handle is formed in the handle fixing device.

In another aspect of the present invention, the rotating disc is rotationally connected with the fixing disc through a rotating arm. A plurality of positioning holes is distributed in the rotating arm in the circumferential direction. A pin-dropping device is arrange on the mower, and a limiting pin is movably arranged in the pin-dropping device. The limiting pin and the positioning holes are interacted to limit the rotating arm.

In another aspect of the present invention, the rotating disc is rotationally connected with the fixing disc through a rotating arm. A gear is arranged at a position where the rotating arm and the fixing disc are connected. A gear motor is arranged on the mower. An output end of the gear motor is in transmission connection with the gear through a linkage shaft.

In another aspect of the present invention, the rotating disc is rotationally connected with the fixing disc through a rotating arm. A gear is arranged at a position where the rotating arm and the fixing disc are connected. The gear is connected with a linkage shaft, and one end of the linkage shaft that is far away from the gear is perpendicularly connected with a connecting arm. A holder rod is rotationally connected with one end of the connecting arm. A plurality of fixing grooves interacting with the holder rod is distributed in the mower along the circumferential direction.

In another aspect of the present invention, the rotating disc is rotationally connected with the fixing disc through a rotating arm. A mounting disc is arranged on the fixing disc, and a U-shaped groove is formed in the mounting disc. A locking device is arranged on the rotating arm, and the locking device comprises a fixing nut and a locking piece. One end of the fixing nut is connected with the rotating arm, and the other end of the fixing nut penetrates through an arc groove. An eccentric block is arranged on the locking device, and the eccentric block is rotationally connected with one end of the fixing nut that penetrates through the arc groove. When the locking piece is rotated, the eccentric block is abutted against the mounting disc, thereby enabling the mounting disc to be closely attached to the rotating arm.

In another aspect of the present invention, the rotating disc is rotationally connected with the fixing disc through a rotating arm. The rotating arm is connected with a first saw-tooth fixing disc, and a second saw-tooth fixing disc interacting with the first saw-tooth fixing disc is arranged on the fixing disc. The abutted surfaces of the first saw-tooth fixing disc and the second saw-tooth fixing disc are respectively provided with a saw-tooth surface. A locking device is arranged on the fixing disc, and the locking device comprises a fixing nut and a locking piece. One end of the fixing nut is connected with the fixing disc, and the other end of the fixing nut penetrates through the fixing disc, the second saw-tooth fixing disc, the first saw-tooth fixing disc and the rotating arm. An eccentric block is arranged on the locking piece, and the eccentric block is rotationally connected with one end of the fixing nut that penetrates through the rotating arm. When the locking piece is rotated, the eccentric block is abutted against the rotating arm, thereby enabling the first saw-tooth fixing disc and the second saw-tooth fixing disc to be closely attached.

In another aspect of the present invention, the rotating disc is rotationally connected with the fixing disc through a rotating arm. A limiting groove is formed in the fixing disc, and a guide groove is formed in the rotating arm. A locking device is arranged on the fixing disc, and the locking device comprises a fixing nut and a locking piece. One end of the fixing nut is connected with the fixing disc, and the other end of the fixing nut penetrates through the limiting groove and the guide groove. An eccentric block is arranged on the locking piece, and the eccentric block is rotationally connected with one end of the fixing nut that penetrates through the guide groove. When the locking piece is rotated, the eccentric block is abutted against the rotating arm, thereby enabling the rotating arm and the fixing disc to be closely attached.

Compared with the prior art, the present invention has the following advantages:

According to the mower folding-type chassis of the present invention, when mowing a lawn with the mower, the rotating discs can be rotated relative to the fixing disc, thereby enabling the rotating discs and the fixing disc to be transversely arranged side by side. Thus, the mowing area of mowing blades in the rotating discs and the fixing disc can be greatly increased, and the mowing efficiency can be significantly improved. When the mower needs to be stored or transported, the rotating discs can be rotated relative to the fixing disc so that the rotating discs and the fixing disc are arranged side by side in a longitudinal direction. At this point, the rotating discs can be partially or completely folded in the mower, thus reducing the space occupation of the mower so that the storage and transportation can be facilitated.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is a schematic diagram illustrating an overall structure of the present invention;

FIG. 2 is a schematic diagram illustrating a structure when the chassis of the present invention is unfolded;

FIG. 3 is a schematic diagram illustrating a structure when the chassis of the present invention is folded;

FIG. 4 is a structural diagram of the chassis of the present invention during the belt transmission;

FIG. 5 is a structural diagram of the chassis of the present invention when driven directly by a motor;

FIG. 6 is a schematic diagram illustrating a structure when the rotating discs in embodiment 1 of the present invention are unfolded;

FIG. 7 is a schematic diagram illustrating a structure when the rotating discs in embodiment 1 of the present invention are folded;

FIG. 8 is a schematic diagram illustrating a structure when the rotating discs in embodiment 2 of the present invention are unfolded;

FIG. 9 is a schematic diagram illustrating a structure when the handle in embodiment 2 of the present invention is opened;

FIG. 10 is a schematic diagram illustrating a structure when the handle in embodiment 2 of the present invention is clamped in the clamping groove;

FIG. 11 is a schematic diagram illustrating a structure when the rotating discs in embodiment 3 of the present invention are unfolded;

FIG. 12 is a schematic diagram illustrating a structure when the rotating discs in embodiment 3 of the present invention are folded;

FIG. 13 is a structural diagram of the pin-dropping device in embodiment 3 of the present invention;

FIG. 14 is a schematic diagram illustrating a structure when the rotating discs in embodiment 4 of the present invention are unfolded;

FIG. 15 is a schematic diagram illustrating a structure when the rotating discs in embodiment 4 of the present invention are folded;

FIG. 16 is a structural diagram of the fixing disc in embodiment 4 of the present invention;

FIG. 17 is a schematic diagram illustrating a structure when the holder rod in embodiment 5 of the present invention is rotated;

FIG. 18 is a schematic diagram illustrating a structure when the holder rod in embodiment 5 of the present invention is clamped in the fixing groove;

FIG. 19 is a schematic diagram illustrating a structure when the rotating discs in embodiment 6 of the present invention are unfolded;

FIG. 20 is a schematic diagram illustrating a structure when the rotating discs in embodiment 6 of the present invention are folded;

FIG. 21 is a structural diagram of the fixing disc in embodiment 6 of the present invention;

FIG. 22 is a schematic diagram illustrating a structure when the rotating discs in embodiment 7 of the present invention are unfolded;

FIG. 23 is a schematic diagram illustrating a structure when the rotating discs in embodiment 7 of the present invention are folded;

FIG. 24 is a structural diagram of the fixing disc in embodiment 7 of the present invention;

FIG. 25 is a schematic diagram illustrating a structure when the rotating discs in embodiment 8 of the present invention are unfolded;

FIG. 26 is a schematic diagram illustrating a structure when the rotating discs in embodiment 8 of the present invention are folded;

FIG. 27 is a structural diagram of the fixing disc in embodiment 8 of the present invention.

### MARKING INSTRUCTIONS OF THE DRAWINGS

Mower 1, Fixing Disc 2, Rotating Disc 3, Mowing Blade 4, Rotating Arm 5, Lead Screw 6, Lead-screw Motor 7, Sliding Block 8, Rocking Bar 9, Handle 10, Handle Seat 11, Handle Fixing Device 12, Clamping Groove 13, Positioning Hole 14, Pin-dropping Device 15, Limiting Pin 16, Gear 17, Linkage Shaft 18, Gear Motor 19, Connecting Arm 20, Holder Rod 21, Fixing Groove 22, Mounting Disc 23, U-shaped Groove 24, Locking Device 25, Fixing Nut 26, Locking Piece 27, Eccentric Block 28, A First Saw-tooth Fixing Disc 29, A Second Saw-tooth Fixing Disc 30, Limiting Groove 31, Guide Groove 32, Gasket 33, Shell 34, Connecting Shaft 35, Bearing 36, Sleeve 37, Connecting Hole 38, Driving Motor 39, Belt Wheel 40, Through Groove 41.

### DETAILED DESCRIPTION OF THE INVENTION

Drawings and detailed embodiments are combined hereinafter to elaborate the technical principles of the present invention.

### Embodiment 1

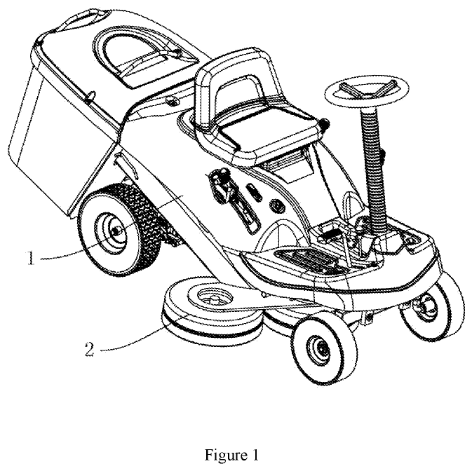

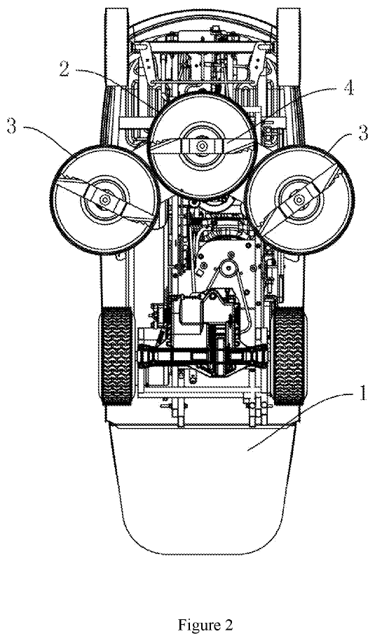

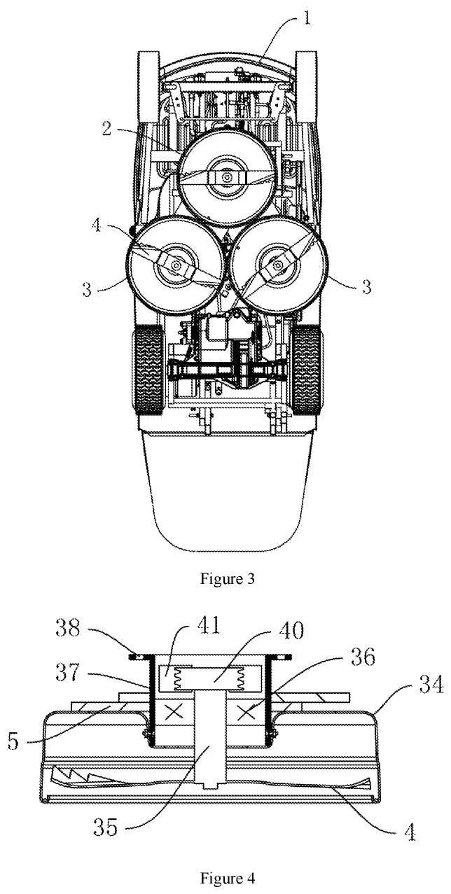

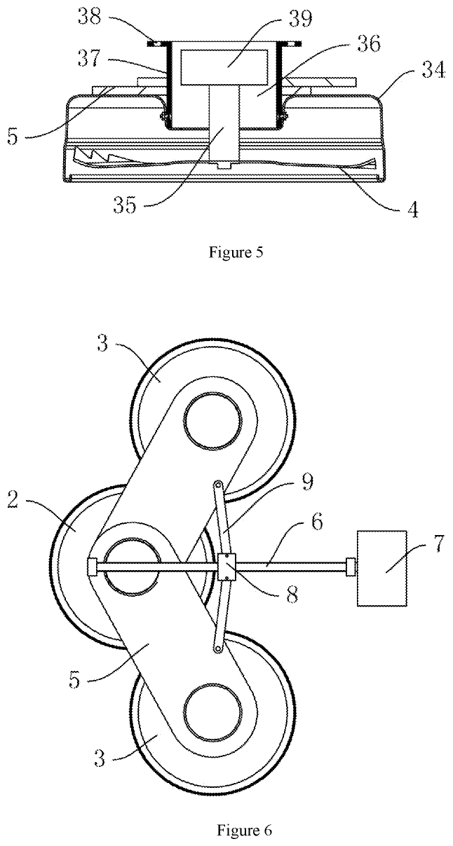

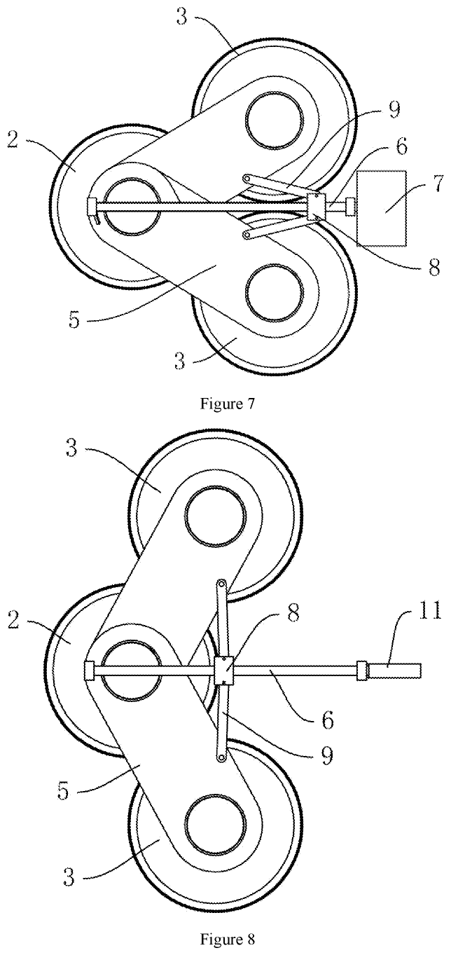

As shown in FIGS. 1-7, the mower folding-type chassis of the present invention comprises a fixing disc 2 and at least one rotating disc 3 rotationally connected with the fixing disc 2. The fixing disc 2 is fixedly arranged at the bottom of the mower 1. When there're two rotating discs 3, each rotating disc 3 is respectively rotationally connected with the fixing disc 2, and when there're more than two rotating discs 3, two of the rotating discs 3 are respectively rotationally connected with the fixing disc 2, and the rest of the rotating discs 3 are respectively rotationally connected with the rotating discs 3 that are connected with the fixing disc 2. Namely, the plurality of the rotating discs 3 is connected in series. The mower 1 of the present invention can be either a pushed mower or a riding mower.

The fixing disc 2 and the rotating disc 3 respectively comprise a shell 34. Mowing blades 4 are respectively arranged within the shells 34 of the fixing disc 2 and the rotating disc 3. The mowing blade 4 is transversely arranged in the shell 34, and a connecting shaft 35 is vertically arranged on the mowing blade 4. A bearing 36 interacting with the connecting shaft 35 is arranged on the shell 34. One end of the connecting shaft 35 is connected with the mowing blade 4, and the other end of the connecting shaft 35 extends into the bearing 36, thereby enabling the mowing blade 4 to be rotationally installed in the shell 34. A sleeve 37 is connected with the shell 34 of the fixing disc 2, and a connecting hole 38 is formed in the top end of the sleeve 37. The sleeve 37 is connected with a frame at the bottom of the mower 1 through the connecting hole 38. The fixing disc 2 is fixedly connected with the frame at the bottom of the mower 1 through the sleeve 37. A driving device used for driving the mowing blades 4 to rotate is arranged in the mower 1, and a grass-discharging hole is formed in the side surface or the top of the shell 34. When the mowing blades 4 are rotated, a wind pressure can be generated to blow the mowed grass out of the chassis.

The driving device further comprises a plurality of driving motors 39, which are respectively arranged on the fixing disc 2 and the rotating disc 3. The driving motors 39 are respectively in transmission connection with the connecting shaft 35 of the mowing blade 4 in the fixing disc 2 and that in the rotating disc 3. The mowing blades 4 in the fixing disc 2 and the rotating disc 3 are driven by the driving motors 39 to rotate, thus conveniently mowing the lawn.

The structure of the driving device can be various. For instance, the driving device comprises a driving motor 39, and the connecting shaft 35 of the mowing blade 4 in the fixing disc 2 and that in the rotating disc 3 penetrate through one end of the shells 34, and are respectively connected with a belt wheel 40. A belt is arranged between the belt wheel 40 on the fixing disc 2 and that on the rotating disc 3 in a sleeved mode. A through groove 41 allowing the belt to pass through is formed in the sleeve 37. The driving motor 39 is arranged either on the fixing disc 2 or on the frame at the bottom of the mower 1, and is rotationally connected with the belt wheel 40 on the fixing disc 2.

When there're two rotating discs 3, two wheel grooves are formed in the belt wheel 40 connected with the mowing blade 4 of the fixing disc 2. Belts are respectively arranged between the two wheel grooves and the belt wheels 40 on the two rotating discs 3 in a sleeved mode. A rotating arm 5 is connected to the center of the fixing disc 2. When the rotating discs 3 are rotated, the distance between the mowing blades 4 in the rotating discs 3 and the mowing blade 4 in the fixing disc 2 is kept unchanged all the time. Thus, the belts are always in a tensioned state. When there're two or more rotating discs 3, belts are respectively arranged between the fixing disc 2 and the rotating discs 3 that are rotationally connected with the fixing disc 2 in a sleeved mode, and belt wheels 40 are respectively arranged between the rotating discs 3 connected with the fixing disc 2 and the rest of the rotating discs 3 in a sleeved mode. At this point, as long as the driving motors 39 are initiated, the mowing blades 4 in both the fixing disc 2 and the rotating discs 3 are driven to rotate through the belts. This design greatly reduces the number of the driving motors so that the cost can be lowered. A tensioning device is further arranged on the rotating arm 5. The tensioning device comprises a tensioning wheel and a spring. The tensioning wheel is rotationally connected with a connecting rod. A stop block is further arranged on the rotating arm 5, and the spring is located between the stop block and the connecting rod. In this way, the tensioning wheel is always abutted against the belt so that the belt is always kept in a tensioned state.

Each rotating disc 3 is rotationally connected to the fixing disc 2 through a rotating arm 5, and the rotating arm 5 is connected to the center of the fixing disc 2. The rotating arm 5 is fixedly connected with the shell 34 of the rotating disc 3 through a bolt. The rotating arm 5 is sleeved outside the sleeve 37, and is rotationally connected with the sleeve 37. Preferably, a sliding groove is formed in the rotating arm 5, and a bolt is arranged on the shell 34 of the fixing disc 2. The bolt penetrates through the shell 34 and the sliding groove, and is connected with a screw cap. The rotating arm 5 can rotate relative to the bolt. Through the arrangement of the sliding groove and the bolt, a limiting function can be achieved when the rotating arm 5 is rotated, thus preventing the rotating arm 5 from excessively rotating or being separated from the sleeve 37. When the number of the rotating discs 3 is two, the number of the rotating arms 5 is also two. At this point, the two rotating arms 5 are arranged on the sleeve 37 in a stacked mode, and the two rotating arms are respectively provided with a sliding groove. Correspondingly, two bolts are arranged on the shell 34 of the fixing disc 2. Gaskets 33 are respectively arranged between the shell 34 of the fixing disc 2 and the rotating arm 5, and between the screw cap and the rotating arm 5, thereby facilitating the rotation of the rotating arm 5.

A lead-screw motor 7 is arranged on the mower 1, and an output end of the lead-screw motor 7 is connected with a lead screw 6 in a transmission mode. A lead screw seat matched with the lead screw 6 is arranged on the fixing disc 2, and a sliding block 8 is arranged on the lead screw 6. The sliding block 8 is connected with a rocking bar 9, and the rocking bar 9 is connected with the rotating arm 5. When the rotating disc 3 needs to be unfolded, the lead-screw motor 7 is initiated to drive the lead screw 6 to rotate. The lead screw 6 is rotated to enable the sliding block 8 to move along the lead screw 6 towards the position where the fixing disc 2 is located, and the rotating arm 5 is driven to rotate through the rocking bar 9 when the lead screw 6 moves. Thus, the rotating disc 3 rotates around the fixing disc 2, and is unfolded relative to the fixing disc 2. The lead-screw motor 7 can be a servo motor, a steering engine, or a motor capable of achieving the same function. The lead-screw motor 7 can be stopped at any time so that the sliding block 8 can be stopped at any position of the lead screw 6. Thus, the unfolding angle of the rotating disc 3 relative to the fixing disc 2 can be adjusted according to actual requirements. At this point, the rotating disc 3 is fixed relative to the fixing disc 2. When the lead-screw motor 7 is initiated to rotate reversely, the rotating disc 3 is driven to fold and retract relative to the fixing disc 2. Namely, the rotational motion of the lead screw 6 is converted into the linear motion of the sliding block 8 by means of a ball screw 6.

When there're two or more rotating discs 3, two of the rotating discs 3 are respectively rotationally connected with the fixing disc 2 through a rotating arm 5, and the rest of the rotating discs are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5. The plurality of rotating discs 3 can be driven by the same lead-screw motor 7. The output end of the lead-screw motor 7 is in transmission connection with a lead screw 6, and a sliding block 8 is arranged on the lead screw 6. A plurality of rocking bars 9 is connected with the sliding block 8, and the plurality of rocking bars 9 is correspondingly connected with the plurality of rotating arms 5. When the lead-screw motor 7 is initiated, the lead screw 6 is driven to rotate, enabling the sliding block 8 to move along the lead screw 6 towards the position where the fixing disc 2 is located. When the lead screw 6 moves, the plurality of rotating arms is driven to rotate simultaneously through the plurality of rocking bars 9, thereby enabling the rotating discs 3 to rotate around the fixing disc 2. Thus, the rotating discs 3 are unfolded relative to the fixing disc 2. According to this design, the number of the lead-screw motors 7, the lead screws and the sliding blocks 8 can be greatly reduced. Certainly, when there're two or more rotating discs 3, the rotating discs 3 can be respectively driven to unfold through a plurality of lead-screw motors 7, lead screws and sliding blocks 8.

According to the mower folding-type chassis of the present invention, when mowing a lawn with the mower 1, the rotating discs 3 can be rotated relative to the fixing disc 2, thereby enabling the rotating discs 3 and the fixing disc 2 to be transversely arranged side by side. Thus, the mowing area of mowing blades 4 in the rotating discs 3 and the fixing disc 2 can be greatly increased, and the mowing efficiency can be significantly improved. When the mower 1 needs to be stored or transported, the rotating discs 3 can be rotated relative to the fixing disc 2 so that the rotating discs 3 and the fixing disc 2 are arranged side by side in a longitudinal direction. At this point, the rotating discs 3 can be partially or completely folded in the mower 1, thus reducing the space occupation of the mower 1 so that the storage and transportation can be facilitated.

### Embodiment 2

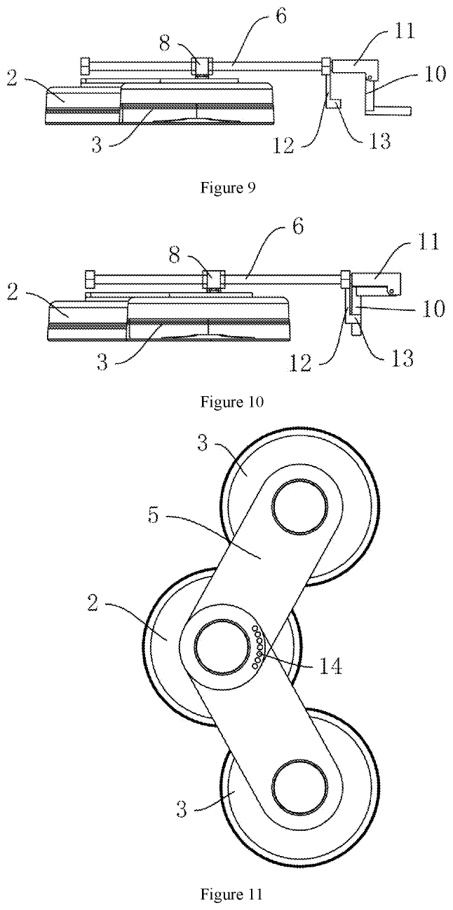

As shown in FIGS. 1-5 and 8-10, the main structure of the mower folding-type chassis of embodiment 2 is the same as that of embodiment 1. What makes embodiment 2 differ from embodiment 1 is the following: a lead screw is arranged on the mower 1; the fixing disc 2 is provided with a lead screw seat matched with the lead screw 6; a sliding block 8 is arranged on the lead screw 6, and the sliding block 8 is connected with a rocking bar 9; the rocking bar 9 is connected with a rotating arm 5, and the end portion of the lead screw 6 is connected with a handle seat 11; a handle is rotationally connected with the handle seat 11, and a handle fixing device 12 is further arranged on the lead screw 6; a clamping groove 13 matched with the handle 10 is formed in the handle fixing device 12. When the rotating disc 3 needs to be unfolded, the lead screw 6 is driven to rotate by rotating the handle 10. The lead screw 6 is rotated to enable the sliding block 8 to move along the screw rod 6 to the position where the fixing disc 2 is located. When the lead screw 6 moves, the rotating arm 5 is driven to rotate through the rocking bar 9, thereby enabling the rotating disc 3 to rotate around the fixing disc 2. Thus, the rotating disc 3 is unfolded relative to the fixing disc 2. When the unfolding angle of the rotating disc 3 relative to the fixing disc 2 satisfies the requirement of actual use, the handle 10 is rotated and clamped subsequently in the clamping groove 13, thereby completing the adjustment. At this point, the rotating disc 3 is fixed relative to the fixing disc 2. When the handle 10 is rotated reversely, the rotating disc 3 is driven to fold and retract relative to be fixing disc 2.

When there're two or more rotating discs, two of the rotating discs 3 are respectively rotationally connected to the center of the fixing disc 2 through a rotating arm 5, and the rest of the rotating discs 3 are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5. At this point, the plurality of rotating discs 3 can be driven by the same lead screw 6. A sliding block 8 is arranged on the lead screw 6. A plurality of rocking bars 9 is connected with the sliding block 8, and the plurality of rocking bars 9 is correspondingly connected with the plurality of rotating arms 5. When the handle 10 is rotated, the lead screw 6 is driven to rotate, enabling the sliding block 8 to move along the lead screw 6 towards the position where the fixing disc 2 is located. When the lead screw 6 moves, the plurality of rotating arms is driven to rotate simultaneously through the plurality of rocking bars 9, thereby enabling the rotating discs 3 to rotate around the fixing disc 2. Thus, the rotating discs 3 are unfolded relative to the fixing disc 2. According to this design, the number of the handles 10, the lead screws and the sliding blocks 8 can be greatly reduced. Certainly, when there're two or more rotating discs 3, the rotating discs 3 can also be respectively driven to unfold through a plurality of handles 10, lead screws and sliding blocks 8.

### Embodiment 3

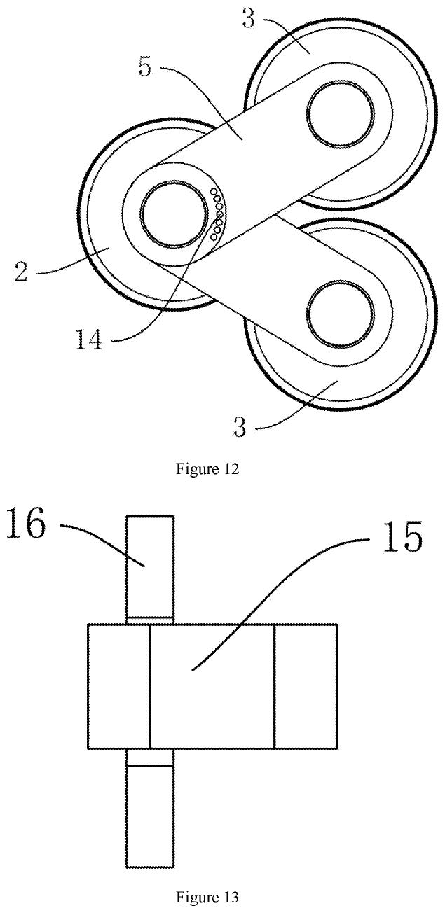

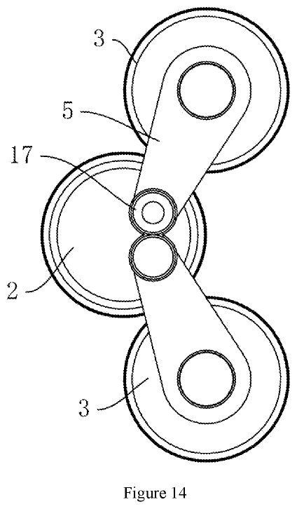

As shown in FIGS. 1-5 and 11-13, the main structure of the mower folding-type chassis of embodiment 3 is the same as that of embodiment 1. The difference between them lies in: a plurality of positioning holes 14 is distributed on the rotating arm 5 along the circumferential direction; a pin-dropping device 15 is arranged on the mower 1, and a limiting pin 16 is movably arranged in the pin-dropping device 15; the limiting pin 16 interacts with the positioning holes 14 for limiting the rotating arm 5. When the rotating disc 3 needs to be unfolded, the rotating disc 3 is rotated relative to the fixing disc 2. When the unfolding angle of the rotating disc 3 relative to the fixing disc 2 satisfies the requirement of actual use, the limiting pin 16 is moved downwards, and is inserted into a positioning hole 14. Thus, the rotating arm 5 is limited, and the rotating disc 3 is fixed relative to the fixing disc 2. When the rotating disc 3 needs to be rotated again, the limiting pin 16 is pulled out and separated from the positioning hole 14. Thus, the rotating arm 5 is no longer limited, and the rotating disc 3 can be rotated again.

When there're two or more rotating discs 3, two of the rotating discs 3 are respectively rotationally connected to the center of the fixing disc 2 through a rotating arm 5, and the rest of the rotating discs 3 are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5. The two rotating discs 3 that are fixedly connected with the fixing disc 2 can be fixed only by one pin-dropping device 15. Namely, the rotating arms 5 of the two rotating discs 3 connected with the fixing disc 2 are respectively provided with positioning holes in the same position, and the positioning holes in the two rotating arms 5 are partially overlapped. After the limiting pin 16 in the pin-dropping device 15 is dropped into the overlapped positioning holes, the two rotating discs 3 that are rotationally connected with the fixing disc 2 can be simultaneously fixed only by one pin-dropping device 15, and the two rotating discs 3 can be adjusted respectively. The rotating angles of the two rotating discs 3 relative to the fixing disc 2 can be different. Certainly, the two rotating discs 3 can be respectively fixed through two pin-dropping devices 15. The rest of the rotating discs 3 are respectively fixed through pin-dropping devices 15. The interacting and adjusting modes are the same as the aforesaid, which are briefly described herein.

### Embodiment 4

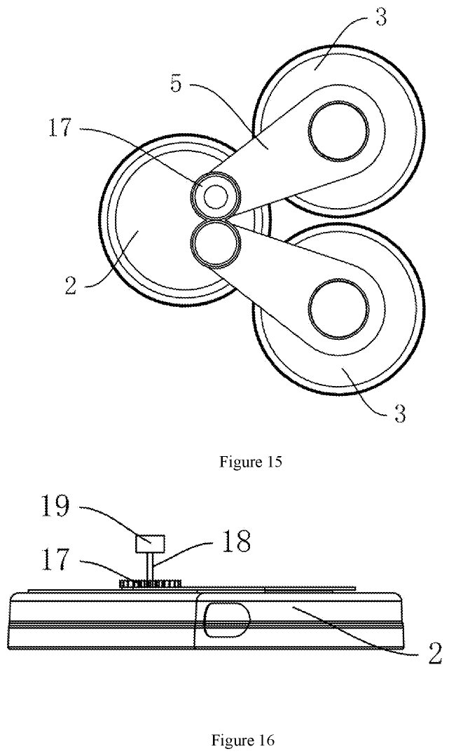

As shown in FIGS. 1-5 and 14-16, the main structure of the mower folding-type chassis of embodiment 4 is the same as that of embodiment 1. The difference between them is: the rotating disc 3 is rotationally connected with the fixing disc 2 through a rotating arm 5, and a gear 17 is arranged at a position where the rotating arm 5 and the fixing disc 2 are connected; a gear motor 19 is arranged on the mower 1, and the output end of the gear motor 19 is in transmission connection with the gear 17 through a linkage shaft 18. When the rotating disc 3 needs to be unfolded, the gear motor 19 is initiated to rotate to drive the gear 17 to rotate through the linkage shaft 18, thereby enabling the rotating disc 3 to rotate relative to the fixing disc 2. Thus, the rotating disc 3 can be unfolded. The gear motor 19 can be stopped at any time so that the unfolding angle of the rotating disc 3 relative to the fixing disc 2 can be adjusted according to the requirement of actual use. At this point, the rotating disc 3 is fixed relative to the fixing disc 2. When the gear motor 19 is initiated to rotate reversely, the rotating disc 3 can be folded and retracted relative to the fixing disc 2.

When there's only one rotating disc 3, a connecting arm 20 is connected to the center of the fixing disc 2, and is arranged outside of the sleeve 37 in a sleeved mode. When there're two or more rotating discs 3, two of the rotating discs 3 are respectively rotationally connected with the fixing disc 2 through a rotating arm 5, and the rest of the rotating discs 3 are respectively rotationally connected with the rotating discs 3 that are connected with the fixing disc 2 through a rotating arm 5. At this point, the two rotating arms 5 are in eccentric connection with the shell 34 of the fixing disc 2, and two sleeves 37 are additionally arranged on the shell 34 of the fixing disc 2. Thus, the two rotating arms 5 are respectively arranged outside the two sleeves 37 in a sleeved mode. Gears 17 arranged on the two rotating arms 5 are meshed with each other. In this way, the rotation of the two rotating discs 3 connected with the fixing disc 2 can be achieved by only one gear motor 19. Namely, gears 17 arranged on the rotating arms 5 of the two rotating discs 3 connected with the fixing disc 2 are meshed with each other. At this point, the gear motor 19 only needs to be in transmission connection with one of the gears 17 through the linkage shaft 18, and both the two gears 17 can be driven to rotate. According to this design, the number of the gear motors 19 can be reduced and the cost can be lowered. Definitely, the distance between the two additionally-arranged sleeves 37 can be increased for preventing the gears 17 arranged on the two rotating arms 5 from interfering with each other. The gears 17 can be respectively driven to rotate by two gear motors 19, and the rest of the rotating discs 3 are respectively driven to rotate by a gear motor 19. The interacting and adjusting modes are the same as the aforesaid, which are briefly described herein.

When there're two or more rotating discs 3, for the gears 17 arranged on the rotating arms 5 of the two rotating discs 3 that are connected with the fixing disc 2 need to be meshed, the rotating arms 5 cannot be connected to the center of the fixing disc 2. In this embodiment, if the fixing disc 2 and the rotating discs 3 are in belt transmission, a tensioning device needs to be arranged on the rotating arm 5. The tensioning device comprises a tensioning wheel and a spring, and a connecting rod is rotationally connected to the tensioning wheel. A stop block is further arranged on the rotating arm 5. The spring is located between the stop block and the connecting rod, enabling the tensioning wheel to abut against the belt all the time. As a result, when the rotating discs 3 rotate relative to the fixing disc 2, the spring can compensate for the looseness generated by the belt. Thus, the belt can always be kept in a tensioned state.

### Embodiment 5

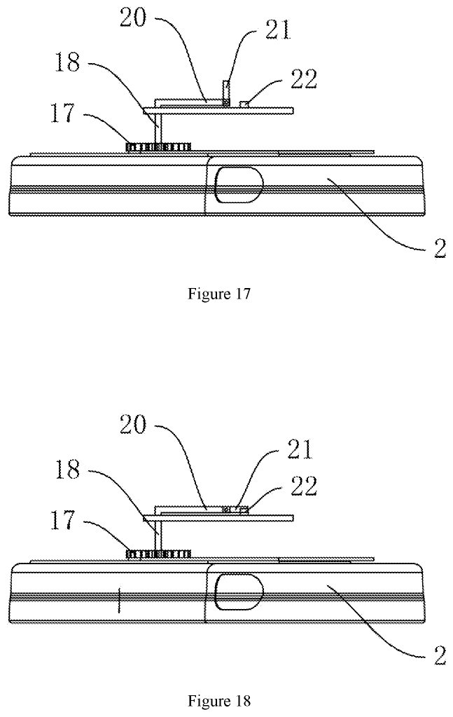

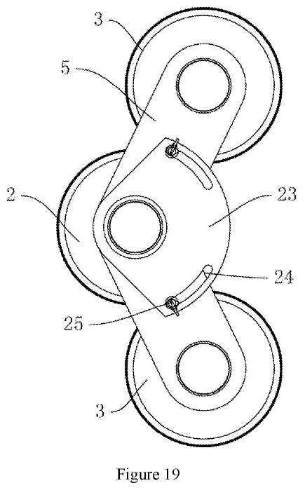

As shown in FIGS. 1-5 and 17-18, the main structure of the mower folding-type chassis of embodiment 5 is the same as that of embodiment 4. The difference between the two embodiments is: a gear is arranged at a position where the rotating arm 5 and the fixing disc 2 are connected; the gear 17 is connected with a linkage shaft 18; a connecting arm 20 is perpendicularly connected to one end of the linkage shaft 18 that is far away from the gear 17, and a holder rod 21 is rotationally connected to one end of the connecting arm 20; a plurality of fixing grooves 22 interacting with the holder rod 21 is distributed on the mower 1 along the circumferential direction. When the rotating disc 3 needs to be unfolded, the holder rod 21 is rotated to drive the gear 17 to rotate through the linkage shaft 18, thereby driving the rotating arm 5 to rotate. The rotating arm 5 further drives the rotating disc 3 to rotate relative to the fixing disc 2 so that the rotating disc 3 can be unfolded. When the unfolding angle of the rotating disc 3 relative to the fixing disc 2 satisfies the requirement of actual use, the holder rod 21 is rotated to be clamped within a fixing groove 22, thereby completing the adjustment. At this point, the rotating disc 3 is fixed relative to the fixing disc 2. When the fixing groove 22 is rotated reversely, the rotating disc 3 is driven to fold and retract relative to the fixing disc 2.

When there's only one rotating disc 3, a connecting arm 20 is connected to the center of the fixing disc 2, and is arranged outside of the sleeve 37 in a sleeved mode. When there're two or more rotating discs 3, two of the rotating discs 3 are respectively rotationally connected with the fixing disc 2 through a rotating arm 5, and the rest of the rotating discs 3 are respectively rotationally connected with the rotating discs 3 that are connected with the fixing disc 2 through a rotating arm 5. At this point, the two rotating arms 5 are in eccentric connection with the shell 34 of the fixing disc 2, and two sleeves 37 are additionally arranged on the shell 34 of the fixing disc 2. Thus, the two rotating arms 5 are respectively arranged outside the two sleeves 37 in a sleeved mode. Gears 17 arranged on the two rotating arms 5 are meshed with each other. In this way, the rotation of the two rotating discs 3 connected with the fixing disc 2 can be achieved by only one gear motor 19. Namely, gears 17 arranged on the rotating arms 5 of the two rotating discs 3 connected with the fixing disc 2 are meshed with each other. At this point, the gear motor 19 can drive both the two gears 17 to rotate through a linkage shaft 18, a connecting arm 20 and a holder rod 21. According to this design, the cost can be greatly reduced. Surely, the distance between the two additionally-arranged sleeves 37 can be increased for preventing the gears 17 arranged on the two rotating arms 5 from interfering with each other, and the gears 17 can be respectively driven to rotate through a linkage shaft 18, a connecting arm 20 and a holder rod 21. The interacting and adjusting modes are the same as the aforesaid, which are briefly described herein.

When there're two or more rotating discs 3, for the gears 17 arranged on the rotating arms 5 of the two rotating discs 3 that are connected with the fixing disc 2 need to be meshed, the rotating arms 5 cannot be connected to the center of the fixing disc 2. In this embodiment, if the fixing disc 2 and the rotating discs 3 are in belt transmission, a tensioning device needs to be arranged on the rotating arm 5. The tensioning device comprises a tensioning wheel and a spring, and a connecting rod is rotationally connected to the tensioning wheel. A stop block is further arranged on the rotating arm 5. The spring is located between the stop block and the connecting rod, enabling the tensioning wheel to abut against the belt all the time. As a result, when the rotating discs 3 are rotated relative to the fixing disc 2, the spring can compensate for the looseness generated by the belt. Thus, the belt can always be kept in a tensioned state.

### Embodiment 6

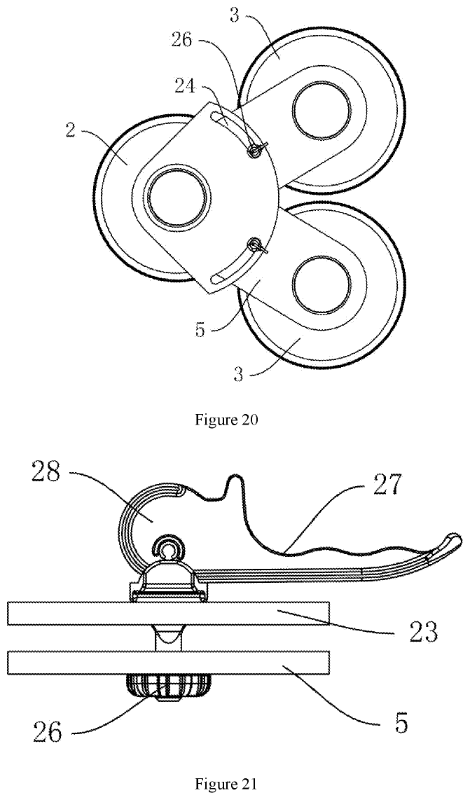

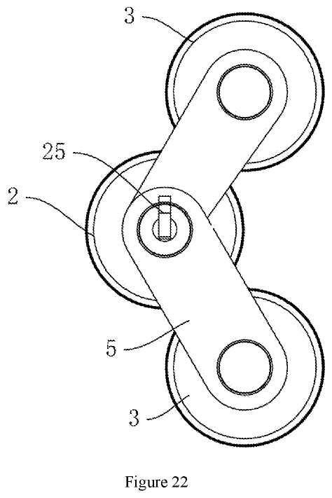

As shown in FIGS. 1-5 and 19-21, the main structure of the mower folding-type chassis of embodiment 6 is the same as that of embodiment 1. The difference between them lies in: a mounting disc 23 is arranged on the fixing disc 2, and the mounting disc 23 is arranged outside the sleeve 37 in a sleeved mode; a U-shaped groove 24 is formed in the mounting disc 23; a locking device 25 is arranged on the rotating arm 5, and the locking device 25 comprises a fixing nut 26 and a locking piece 27; one end of the fixing nut 26 is connected to the rotating arm 5, and the other end of the fixing nut 26 penetrates through an arc groove; an eccentric block 28 is arranged on the locking piece 27, and the eccentric block 28 is rotationally connected to one end of the fixing nut 26 that penetrates through the arc groove. When the locking piece 27 is rotated, the eccentric block 28 is abutted against the mounting disc 23, thereby enabling the mounting disc 23 to be closely attached to the rotating arm 5. When the rotating disc 3 needs to be unfolded, the rotating disc 3 is rotated relative to the fixing disc 2. Once the unfolding angle of the rotating disc 3 relative to the fixing disc 2 satisfies the requirement of actual use, the locking piece 27 is rotated, and the eccentric block 28 is abutted against the mounting disc 23, thereby enabling the mounting disc 23 to be closely attached to the rotating arm 5. Thus, the rotating arm 5 is limited and the rotating disc 3 is fixed relative to the fixing disc 2. When the rotating disc 3 needs to be rotated again, the locking piece 27 can be rotated reversely. In this way, the eccentric block 28 no longer is abutted against the mounting disc 23, and the rotating arm 5 is no longer limited so that the rotating disc 3 can be rotated again.

When there're two or more rotating discs 3, two of the rotating discs 3 are respectively rotationally connected to the center of the fixing disc 2 through a rotating arm 5, and the rest of the rotating discs 3 are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5. Mounting discs 23 are respectively arranged on the rotating discs 3, and U-shaped grooves 24 are respectively formed in the mounting discs 23. Locking devices 25 are respectively arranged on the rotating arms 5 of the rest of the rotating discs 3. The locking device 25 comprises a fixing nut 26 and a locking piece 27. One end of the fixing nut 26 is connected to the rotating arm 5, and the other end of the fixing nut 26 penetrates through an arc groove. An eccentric block 28 is arranged on the locking piece 27, and the eccentric block 28 is rotationally connected to one end of the fixing nut 26 that penetrates through the arc groove. Thus, the rest of the rotating discs 3 can be rotationally adjusted and fixed relative to the rotating discs 3 connected with the fixing disc 2. The interacting and adjusting modes are the same as the aforesaid, which are briefly described herein.

### Embodiment 7

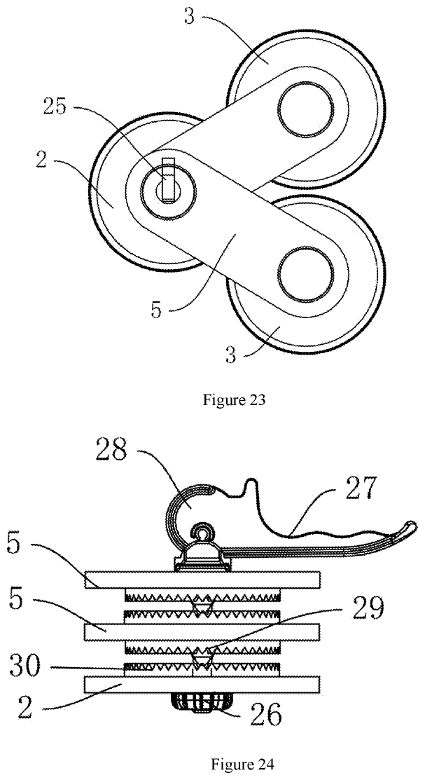

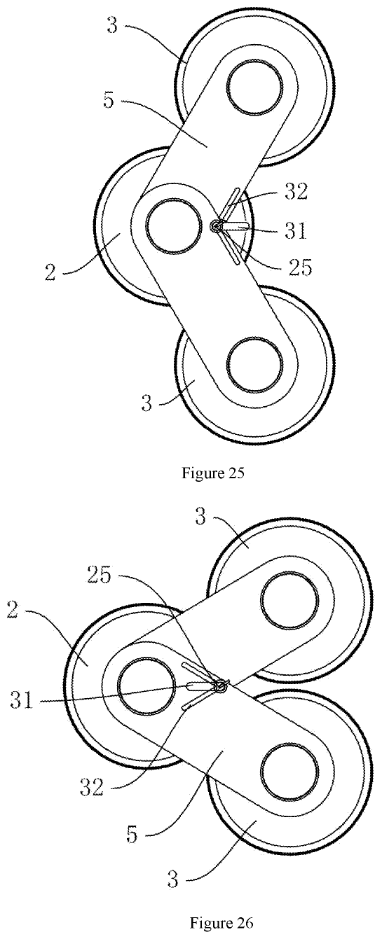

As shown in FIGS. 1-5 and 22-24, the main structure of the mower folding-type chassis of embodiment 7 is the same as that of embodiment 6. The difference between them lies in: a first saw-tooth fixing disc 29 is connected with the rotating arm 5, and a second saw-tooth fixing disc 30 interacting with the first saw-tooth fixing disc 29 is arranged on the fixing disc 2; the first saw-tooth fixing disc 29 and the second saw-tooth fixing disc 30 are arranged outside the sleeve 37 in a sleeved mode; the abutted surfaces of the first saw-tooth fixing disc 29 and the second saw-tooth fixing disc 30 are respectively provided with a saw-tooth surface; a locking device 25 is arranged on the fixing disc 2, and the locking device 25 comprises a fixing nut 26 and a locking piece 27; one end of the fixing nut 26 is connected with the fixing disc 2, and the other end of the fixing nut 26 penetrates through the fixing disc 2, the second saw-tooth fixing disc 30, the first saw-tooth fixing disc 29 and the rotating arm 5; an eccentric block 28 is arranged on the locking piece 27, and is rotationally connected with one end of the fixing nut 26 that penetrates through the rotating arm 5. When the locking piece 27 is rotated, the eccentric block 28 is abutted against the rotating arm 5 so that the first saw-tooth fixing disc 29 is closely attached to the second saw-tooth fixing disc 30.

When the rotating disc 3 needs to be unfolded, the rotating disc 3 is rotated relative to the fixing disc 2, thereby enabling the first saw-tooth fixing disc 29 to rotate relative to the second saw-tooth fixing disc 30. Thus, the adjustment can be achieved. When the unfolding angle of the rotating disc 3 relative to the fixing disc 2 satisfies the requirement of actual use, the locking piece 27 is rotated, and the eccentric block 28 is abutted against the rotating arm 5, thereby enabling the first saw-tooth fixing disc 29 to be closely attached to the second saw-tooth fixing disc 30. Thus, the rotating arm 5 is limited and the rotating disc 3 is fixed relative to the fixing disc 2. When the rotating disc 3 needs to be rotated again, the locking piece 27 is rotated reversely. As a consequence, the eccentric block 28 is no longer abutted against the rotating arm 5, and the first saw-tooth fixing disc 29 is not closely attached to the second saw-tooth fixing disc 30. At this point, the rotating arm 5 can be rotated relative to the fixing disc 2.

When there're two rotating discs 3, the two rotating discs 3 are respectively connected to the center of the fixing disc 2 through a rotating arm 5. The rotating arm 5 of one rotating disc 3 that is rotationally connected with the fixing disc 2 is connected with a first saw-tooth fixing disc 29. A second saw-tooth fixing disc 30 interacting with the first saw-tooth fixing disc 29 is arranged on the fixing disc 2. A third saw-tooth fixing disc is further arranged on the other surface of the rotating arm 5 provided with the first saw-tooth fixing disc 29. A fourth saw-tooth fixing disc interacting with the third saw-tooth fixing disc is arranged on the rotating arm 5 of the other rotating disc 3 that is rotationally connected with the fixing disc 2. The first saw-tooth fixing disc 29, the second saw-tooth fixing disc 30, the third saw-tooth fixing disc and the fourth saw-tooth fixing disc are respectively provided with a saw-tooth surface. Moreover, the first saw-tooth fixing disc 29, the second saw-tooth fixing disc 30, the third saw-tooth fixing disc and the fourth saw-tooth fixing disc are respectively arranged outside the sleeve 37 in a sleeved mode. A locking device 25 is arranged on the fixing disc 2, and the locking device 25 comprises a fixing nut 26 and a locking piece 27. One end of the fixing nut 26 is connected with the fixing disc 2, and the other end of the fixing nut 26 penetrates through the fixing disc 2, the second saw-tooth fixing disc 30, the first saw-tooth fixing disc 29, the rotating arm 5 and the third saw-tooth fixing disc. An eccentric block 28 is arranged on the locking piece 27, the fourth saw-tooth fixing disc and the other rotating arm 5. The eccentric block 28 is rotationally connected with one end of the fixing nut 26 that penetrates through the other rotating arm 5. When the locking piece 27 is rotated, the eccentric block 28 is abutted against the rotating arm 5, thus enabling the first saw-tooth fixing disc 29, the second saw-tooth fixing disc 30, the third saw-tooth fixing disc and the fourth saw-tooth fixing disc to be closely attached.

When there're more than two rotating discs 3, two of the rotating discs 3 are respectively rotationally connected to the center of the fixing disc 2 through a rotating arm 5, and the rest of the rotating discs 3 are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5.

The rotating discs 3 that are rotationally connected with the fixing disc 2 are respectively provided with a saw-tooth fixing disc and a locking device 25, and the rotating arms 5 of the rest of the rotating discs that are connected with the rotating discs 3 connected with the fixing disc 2 are respectively provided with the other saw-tooth fixing disc interacting with the aforesaid saw-tooth fixing disc. The interacting and adjusting modes are the same as the aforesaid, which are briefly described herein.

### Embodiment 8

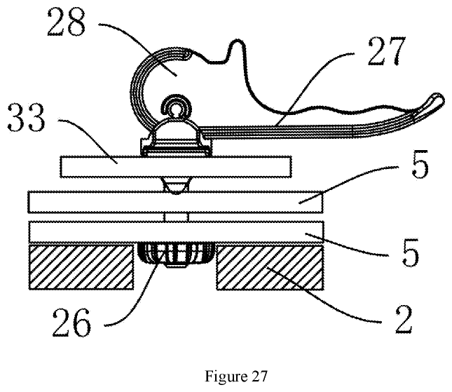

As shown in FIGS. 1-5 and 25-27, the main structure of the mower folding-type chassis of embodiment 8 is the same as that of embodiment 6. The difference between them is: a limiting groove 31 is formed in the fixing disc 2, and a guide groove 32 is formed in the rotating arm 5; a locking device 25 is arranged on the fixing disc 2, and the locking device 25 comprises a fixing nut 26 and a locking piece 27; one end of the fixing nut 26 is connected with the fixing disc 2, and the other end of the fixing disc 26 penetrates through the limiting groove 31 and the guide groove 32. An eccentric block 28 is arranged on the locking piece 27, and the eccentric block 28 is rotationally connected to one end of the fixing nut 26 that penetrates through the guide groove 32. When the locking piece 27 is rotated, the eccentric block 28 is abutted against the rotating arm 5, thereby enabling the rotating arm 5 to be closely attached to the fixing disc 2. Preferably, one end of the fixing nut 26 that penetrates through the guide groove 32 is provided with a gasket 33. The eccentric block 28 is abutted against the rotating arm 5 through the gasket 33. Thus, the contact area is increased so that a tighter attachment can be achieved.

When the rotating disc 3 needs to be unfolded, the rotating disc 3 is rotated relative to the fixing disc 2. During the rotating process of the rotating disc 3, the fixing nut 26 moves along the limiting groove 31 through the guide groove 32. When the unfolding angle of the rotating disc 3 relative to the fixing disc 2 satisfies the requirement of actual use, the locking piece 27 is rotated, and the eccentric block 28 is abutted against the rotating arm 5, enabling the rotating arm 5 and the fixing disc 2 to be closely attached. Thus, the rotating disc 3 is fixed relative to the fixing disc 2. The mounting disc 23 is closely attached to the rotating arm 5, thereby limiting the rotating arm 5. Thus, the rotating disc 3 is fixed relative to the fixing disc 2. When the rotating disc 3 needs to be rotated again, the locking piece 27 is rotated reversely so that the eccentric block 28 is no longer abutted against the rotating arm 5. Thus, the rotating arm 5 is not limited and the rotating disc 3 can be rotated again.

When there're more than two rotating discs 3, two of the rotating discs 3 are respectively rotationally connected to the center of the fixing disc 2 through a rotating arm 5, and the rest of the rotating discs 3 are respectively rotationally connected with the rotating discs 3 that are connected with the fixing disc 2 through a rotating arm 5. At this point, a sleeve 37 is arranged on the shell 34 of each rotating disc 3 that is rotationally connected to the fixing disc 2. Thus, the rotating discs 3 connected with the fixing disc 2 can be conveniently rotationally connected with the rest of the rotating discs through rotating arms 5. Guide grooves 32 are respectively formed in the rotating arms of the fixing discs 3 that are rotationally connected with the fixing disc 2. The other end of the fixing nut 26 penetrates through the limiting groove 31 and the two guide grooves 32, and is connected with the locking piece 27. The rotating discs 3 that are rotationally connected with the fixing disc 2 are respectively provided with a limiting groove 31 and a locking device 25, and the rotating arms 5 of rest of the rotating discs 3 are respectively provided with a guide groove 32. The fixing nut 26 penetrates through the limiting groove 31 and the guide groove 32, and is connected with the locking piece 27. The interacting and adjusting modes are the same as the aforesaid, which are briefly described herein.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A mower folding-type chassis, comprising:
a fixing disc, and
at least one rotating disc rotationally connected with the fixing disc, wherein the fixing disc is fixedly arranged at the bottom of the mower, wherein mowing blades are respectively arranged within the fixing disc and the rotating disc, wherein a driving device used for driving the mowing blades to rotate is arranged in the mower.

2. The mower folding-type chassis of claim 1, wherein the number of the rotating discs is two, and the two rotating discs are respectively rotationally connected with the fixing disc.

3. The mower folding-type chassis of claim 1, wherein when the number of the rotating discs is more than two, two of the rotating discs are respectively rotationally connected with the fixing disc, and the rest of the rotating discs are respectively rotationally connected with the rotating discs that are connected with the fixing disc.

4. The mower folding-type chassis of claim 1, wherein the driving device comprises a plurality of driving motors, which are respectively arranged on the fixing disc and the rotating disc, wherein the driving motors are respectively in transmission connection with the mowing blades in the fixing disc and the rotating disc.

5. The mower folding-type chassis of claim 1, wherein the driving device comprises a driving motor, and the mowing blades in the fixing disc and the rotating disc are respectively connected with a belt wheel, wherein a belt is arranged between the belt wheel on the fixing disc and that on the rotating disc in a sleeved mode, wherein the driving motor is in transmission connection with the belt wheel on the fixing disc.

6. The mower folding-type chassis of claim 1, wherein the rotating disc is rotationally connected with the fixing disc through a rotating arm, wherein a lead-screw motor is arranged on the mower, wherein an output end of the lead-screw motor is in transmission connection with a lead screw, wherein a sliding block is arranged on the lead screw, and the sliding block is connected with a rocking bar, wherein the rocking bar is connected with the rotating arm.

7. The mower folding-type chassis of claim 1, wherein the rotating disc is rotationally connected with the fixing disc through a rotating arm, wherein a lead screw is arranged on the mower, and a sliding block is arranged on the lead screw, wherein the sliding block is connected with a rocking bar, and the rocking bar is connected with the rotating arm, wherein the end portion of the lead screw is connected with a handle through a handle seat.

8. The mower folding-type chassis of claim 1, wherein the rotating disc is rotationally connected with the fixing disc through a rotating arm, wherein a plurality of positioning holes is distributed in the rotating arm in the circumferential direction, wherein a pin-dropping device is arrange on the mower, and a limiting pin is movably arranged in the pin-dropping device, wherein the limiting pin and the positioning holes are interacted to limit the rotating arm.

9. The mower folding-type chassis of claim 1, wherein the rotating disc is rotationally connected with the fixing disc through a rotating arm, wherein a gear is arranged at a position where the rotating arm and the fixing disc are connected, wherein a gear motor is arranged on the mower, wherein an output end of the gear motor is in transmission connection with the gear through a linkage shaft.

10. The mower folding-type chassis of claim 1, wherein the rotating disc is rotationally connected with the fixing disc through a rotating arm, and a gear is arranged at a position where the rotating arm and the fixing disc are connected, wherein the gear is connected with a linkage shaft, and one end of the linkage shaft that is far away from the gear is connected with a holder rod through the rotating arm.

11. The mower folding-type chassis of claim 1, wherein the rotating disc is rotationally connected with the fixing disc through a rotating arm, wherein a mounting disc is arranged on the fixing disc, and a U-shaped groove is formed in the mounting disc, wherein a locking device is arranged on the rotating arm, and the locking device comprises a fixing nut and a locking piece, wherein one end of the fixing nut is connected with the rotating arm, and the other end of the fixing nut penetrates through an arc groove, wherein an eccentric block is arranged on the locking device, and the eccentric block is rotationally connected with one end of the fixing nut that penetrates through the arc groove, wherein when the locking piece is rotated, the eccentric block is abutted against the mounting disc, thereby enabling the mounting disc to be closely attached to the rotating arm.

12. The mower folding-type chassis of claim 1, wherein the rotating disc is rotationally connected with the fixing disc through a rotating arm, wherein the rotating arm is connected with a first saw-tooth fixing disc, and a second saw-tooth fixing disc interacting with the first saw-tooth fixing disc is arranged on the fixing disc, wherein the abutted surfaces of the first saw-tooth fixing disc and the second saw-tooth fixing disc are respectively provided with a saw-tooth surface, wherein a locking device is arranged on the fixing disc, and the locking device comprises a fixing nut and a locking piece, wherein one end of the fixing nut is connected with the fixing disc, and the other end of the fixing nut penetrates through the fixing disc, the second saw-tooth fixing disc, the first saw-tooth fixing disc and the rotating arm, wherein an eccentric block is arranged on the locking piece, and the eccentric block is rotationally connected with one end of the fixing nut that penetrates through the rotating arm, wherein when the locking piece is rotated, the eccentric block is abutted against the rotating arm, thereby enabling the first saw-tooth fixing disc and the second saw-tooth fixing disc to be closely attached.

13. The mower folding-type chassis of claim 1, wherein the rotating disc is rotationally connected with the fixing disc through a rotating arm, wherein a limiting groove is formed in the fixing disc, and a guide groove is formed in the rotating arm, wherein a locking device is arranged on the fixing disc, and the locking device comprises a fixing nut and a locking piece, wherein one end of the fixing nut is connected with the fixing disc, and the other end of the fixing nut penetrates through the limiting groove and the guide groove, wherein an eccentric block is arranged on the locking piece, and the eccentric block is rotationally connected with one end of the fixing nut that penetrates through the guide groove, wherein when the locking piece is rotated, the eccentric block is abutted against the rotating arm, thereby enabling the rotating arm and the fixing disc to be closely attached.

14. The mower folding-type chassis of claim 2, wherein the driving device comprises a plurality of driving motors, which are respectively arranged on the fixing disc and the rotating disc, wherein the driving motors are respectively in transmission connection with the mowing blades in the fixing disc and the rotating disc.

15. The mower folding-type chassis of claim 3, wherein the driving device comprises a plurality of driving motors, which are respectively arranged on the fixing disc and the rotating disc, wherein the driving motors are respectively in transmission connection with the mowing blades in the fixing disc and the rotating disc.

16. The mower folding-type chassis of claim 2, wherein the driving device comprises a driving motor, and the mowing blades in the fixing disc and the rotating disc are respectively connected with a belt wheel, wherein a belt is arranged between the belt wheel on the fixing disc and that on the rotating disc in a sleeved mode, wherein the driving motor is in transmission connection with the belt wheel on the fixing disc.

17. The mower folding-type chassis of claim 3, wherein the driving device comprises a driving motor, and the mowing blades in the fixing disc and the rotating disc are respectively connected with a belt wheel, wherein a belt is arranged between the belt wheel on the fixing disc and that on the rotating disc in a sleeved mode, wherein the driving motor is in transmission connection with the belt wheel on the fixing disc.
